(19) United States
(12) Patent Application Publication
(10) Pub. No.: US 2023/0110746 A1
(43) Pub. Date: Apr. 13, 2023

(54) CHARGING POLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 17/906,073

(22) PCT Filed: Mar. 9, 2021
(86) PCT No.: PCT/EP2021/055943

§ 371 Date: Sep. 11, 2022

(30) Foreign Application Priority Data
Mar. 10, 2020 (DE) 10 2020 106 542.6

(51) Int. Cl. B60L 53/66; B60L 53/18; B60L 53/65; H02J 7/00

(52) U.S. Cl. CPC B60L 53/66; B60L 53/18; B60L 53/65; H02J 7/00032

(57) ABSTRACT

The invention relates to a method for generating and delivering charging current for an electric vehicle in a charging pole with the method steps of registering a first initial process, evaluating the first initial process, starting the charging process depending on the evaluation result, wherein the first initial process is different from a start command of a user for starting a charging process, and a charging pole for carrying out the method.

The invention relates to a method for generating and delivering charging current for an electric vehicle in a charging pole with the method steps of registering a first initial process, evaluating the first initial process, starting the charging process depending on the evaluation result, wherein the first initial process is different from a start command of a user for starting a charging process, and a charging pole for carrying out the method.

### STATE OF THE ART

Currently, charging processes to recharge electric vehicles powered by an electric motor require a relatively long time compared to refueling vehicles powered by a liquid fuel (mainly petrol or diesel fuel). This is partly due to the low charging power of a charging device, e.g. a charging pole.

Another reason is the relatively long time a user has to spend to connect a charging cable, authenticate and pay for the charging process. In addition, especially in areas with a low density of charging options, it is difficult to find an unoccupied charging option when an electric vehicle is currently parked for a long time at one of these charging options, which further prolongs the charging process.

It is therefore the object of the present invention to provide a method for generating and delivering charging current for electric vehicles, with which an electric vehicle can be charged faster and more conveniently for a user.

It is also the object of the present invention to provide a charging pole for charging electric vehicles, with which an electric vehicle can be charged more quickly and more conveniently for a user.

The task is solved by means of the method for generating and delivering charging current for an electric vehicle according to claim 1. Further advantageous embodiments of the invention are set out in the dependent claims.

The method for generating and delivering charging current for an electric vehicle has three steps: In the first process step, a first initial process is registered. The first initial process can be registered by an active user input in the immediate vicinity of the charging pole. An input into an HMI unit on the charging pole for example is possible. It is also possible to make an input, e.g. via a smartphone, from a spatial distance to the charging pole. Advantageously, the first initial process can also be registered without active user input, e.g. by parking an electric vehicle to be charged in the immediate or indirect vicinity of the charging pole. In the second method step, the first initial process is evaluated. In particular, a time and/or a time window is evaluated in which a charging process will take place. Additionally, parameters for the actual charging process can be determined. In the third process step, the charging process is started depending on the evaluation result.

According to the invention, the first initial process is different from a start command of a user to start a charging process. A start command of a user in the context of this disclosure is an active input of the user into one or more control elements on the charging pole and/or an active input into a communication device connected to the charging pole, e.g. a smartphone. A transfer of electrical energy from the charging pole to the electric vehicle takes place immediately after the start command of a user.

In the context of this disclosure, the start of a charging process is understood to be not only the delivery of electrical energy to an electric vehicle, but also the start and/or termination of the delivery of electrical energy to an electric vehicle.

Also for the purposes of this disclosure, the start of a charging process is understood to mean in particular the start of an energy conversion, e.g. from a liquid and/or gaseous energy carrier into electrical energy, the actual process of energy conversion and the termination of the energy conversion.

Also for the purposes of this disclosure, the start of a charging process is understood to be the start of a billing process, i.e. the payment process for the electrical energy delivered to an electric vehicle, the billing process and the termination of a billing process.

Furthermore, for the purposes of this disclosure, the start of a charging process is understood to be the activation of an electrical component that is part of the power supply line between the connection for the charging cable and the connection of the charging pole to a power grid and/or an energy conversion unit for providing electrical energy for the charging process. This can be, for example, a buffer storage for electrical energy intended for charging electric vehicles, an inverter and/or rectifier, a power supply unit and/or a voltage converter.

An energy conversion in the sense of this disclosure can take place, for example, through photovoltaics, conversion of wind power to electrical energy, through a fuel cell and/or a combustion engine with a connected generator, or also the conversion of alternating current to direct current or vice versa.

For the purposes of this disclosure, an electric vehicle is a motor vehicle which is at least partially driven by an electric motor which, in order to drive the motor vehicle, must be supplied with electricity from an electrical energy storage device located in the motor vehicle. Electric vehicles of this type are, for example, pure electric vehicles (BEV), as well as plug-in hybrid vehicles, e-scooters, e-scooters and e-bikes.

In particular, the first initial process is registered before a user gives a start command to start a charging process. The charging process therefore starts before a user gives a start command. This significantly reduces the time of a charging process for charging an electric vehicle by carrying out various steps of an energy transfer between charging pole and electric vehicle before the actual start command of a user to start a charging process.

In particular it should be mentioned that the starting process of an energy conversion from a liquid and/or gaseous energy carrier into electrical energy usually takes a lot of time.

In a further development of the invention, the first initial process is the reception of a sensor signal. In the simplest case, the sensor signal is used to detect that an electric vehicle is in the immediate vicinity of a charging pole for charging. Alternatively or additionally, the sensor signal may provide information about the time of the start of the charging process. Optionally, the approach of a user to the charging pole can also be detected as an initial process.

In another embodiment of the invention, the sensor signal is evaluated by a control unit in the charging pole. The control unit is a computer located in the charging pole with corresponding software/app that enables an evaluation of the sensor signal.

In another embodiment of the invention, the first initial process is performed by a first user input. The first initial process may be registered by an active user input in the immediate vicinity of the charging device. For example, an input into an HMI unit at the charging device is possible. An input, e.g. via a smartphone, from a spatial distance to the charging device is also possible.

In another aspect of the invention, the first user input is made by a first input at an element of the charging pole. The first initial process is registered by a user input in close proximity to the charging pole. The user input element may be a keyboard, a fingerprint and/or facial recognition sensor, and/or a card reader.

In a further embodiment of the invention, the user's first input at an element of the charging pole is made by a first input at the control panel. The first input of a user serves in particular to reserve the charging pole and to initialise the billing process.

In a further embodiment of the invention, the user's first input is made by removing and/or connecting a charging cable. In the charging cable, in addition to the power line for a power transmission from the charging device to the electric vehicle, a data line is usually also arranged. Parameters of the electric vehicle to be charged are transmitted to the charging pole via this, e.g. whether the electric vehicle must be charged with direct current or alternating current. The vehicle and/or user can also be authenticated via the data line.

In a particularly advantageous embodiment of the invention, the user's first input is made via a network to the charging pole, e.g. via a smartphone or the vehicle itself from a spatial distance to the charging pole. For this purpose, the charging pole can be connected to a network to which a plurality of charging pole are connected. A user can thus reserve a specific charging pole and/or for the electric vehicle and for the selected time suitable charging pole.

In another aspect of the invention, the first input of the user is made by a pre-registration of the user via app/internet, e.g. via a smartphone having a corresponding app. A user can thus reserve a specific charging pole and/or for the electric vehicle and for the selected time suitable charging pole.

In an advantageous embodiment of the invention, the first initial process is carried out by detecting a vehicle in the charging location. For this purpose, the charging pole advantageously has a sensor unit. The charging process is started without any active input from a user.

In another aspect of the invention, the first initial process is performed by authenticating the user. Authentication can be performed by various means, e.g. by entering a password, fingerprint or facial recognition or a card reader. It is also possible to authenticate the electric vehicle to be charged, which has a corresponding device. Authentication serves in particular to validate the charging process and to bill it.

In another embodiment of the invention, the start of the charging process comprises a wake-up from a stand-by mode. The charging device is usually in a stand-by mode between two charging processes. This particularly reduces the energy consumption of the charging device itself.

In a further embodiment of the invention, the start of the charging process comprises starting the energy conversion. Depending on the design of the charging pole, an energy conversion requires a lead time in order to be able to deliver maximum power to the electric vehicle during a charging process. For example, the lead time of an energy conversion from light to electricity by e.g. a solar cell is shorter than the lead time of an energy conversion of a liquid and/or gaseous energy carrier by e.g. an internal combustion engine. By suitably selecting the start time of an energy conversion by means of a combustion engine, the charging process for a user is significantly reduced.

In another aspect of the invention, starting the charging process comprises transferring energy to an electric vehicle. Based on the method according to invention, the charging device delivers electrical energy to the electric vehicle during the charging process with optimally selected parameters based on the evaluation of the first initial process. During the charging process, the electric vehicle is connected to the charging pole via a charging cable.

The task is also solved by means of the charging pole according to claim 15. Further embodiments of the invention are disclosed in the dependent claims following claim 15.

The charging pole according to the invention, which is suitable for charging electric vehicles, has an energy conversion unit, a power and HMI unit and a control unit for controlling the charging process. By means of the HMI unit, a user can operate the charging pole. For this purpose, the HMI unit has display and control elements arranged at and/or in the vicinity of the charging pole. The HMI unit is used in particular for entering and/or recording user data. These can be entered and recorded, for example, via a keyboard, with a fingerprint sensor, a sensor for facial recognition and a card reader.

According to the invention, the charging pole comprises a sensor unit. The sensor unit may comprise and/or be connected to different sensors such as radar ultrasonic sensors and/or a camera. The sensor unit can also be designed as a communication device with which data can be received and/or sent via a network, for example.

In another embodiment of the invention, the sensor unit is coupled to the control unit in the charging pole. The control unit is a computer located in the charging pole with corresponding software/app that enables an evaluation of a sensor signal.

In an advantageous embodiment of the invention, the sensor unit is suitable for detecting a vehicle in a charging location assigned to the charging pole. The charging process is started without any active input from a user.

In another aspect of the invention, the sensor unit is adapted to detect the removal and/or connection of a charging cable. In the charging cable, in addition to the power line for a power transmission from the charging pole to the electric vehicle, a data line is usually also arranged. Via this line, parameters of the electric vehicle to be charged are transmitted to the charging pole, e.g. whether the electric vehicle has to be charged with direct current or with alternating current.

Examples of embodiments of the method for charging electric vehicles according to the invention and of the charging pole according to the invention are shown schematically in simplified form in the drawings and are explained in more detail in the following description.

Showing:

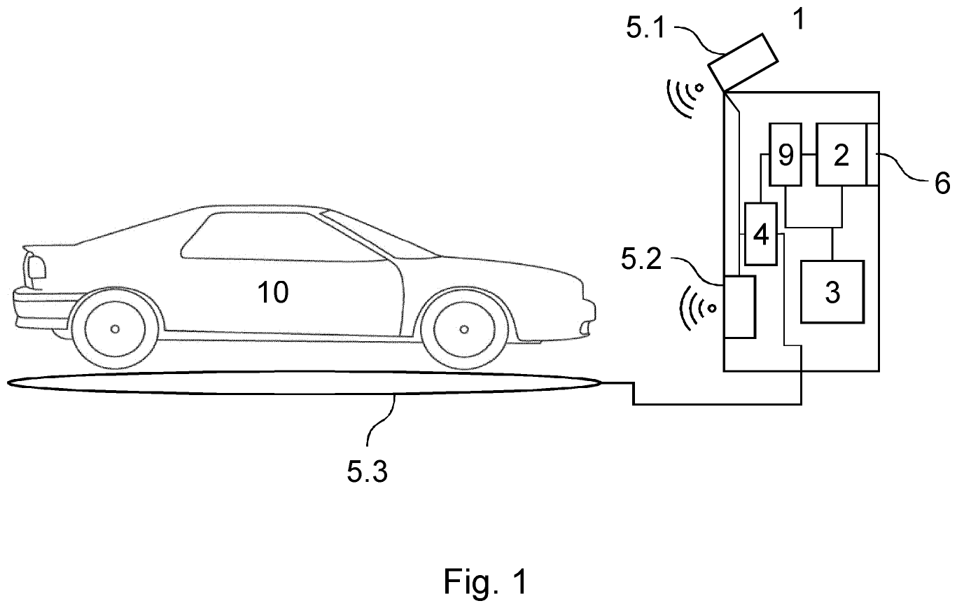

FIG. 1: An embodiment of the method for generating and delivering charging current for an electric vehicle according to the invention.

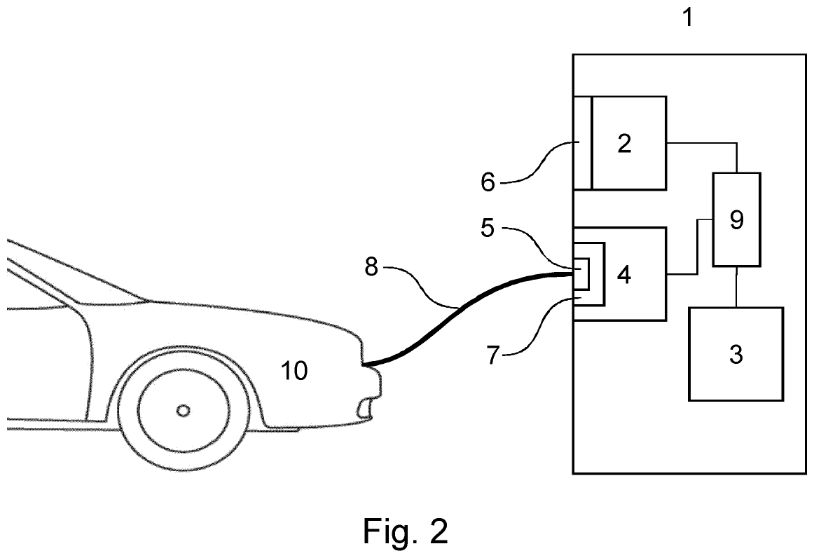

FIG. 2: Another example of the method for generating and delivering charging current for an electric vehicle according to the invention; first initial process is registered by means of a charging cable.

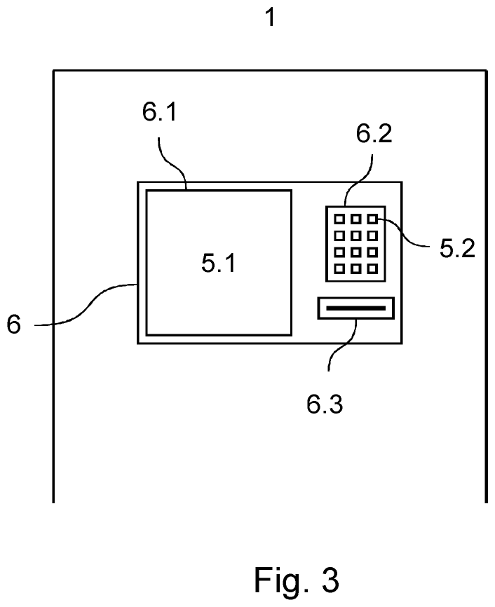

FIG. 3: A further embodiment of the method for generating and delivering charging current for an electric vehicle according to the invention; first initial process registered by means of authentication of a user by the display and operating terminal.

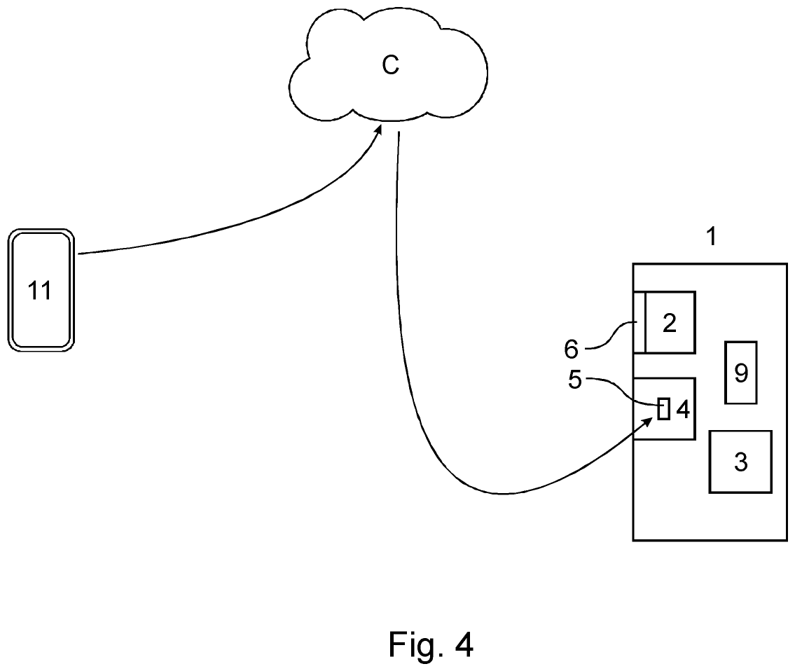

FIG. 4: Another example of the method for generating and delivering charging current for an electric vehicle according to the invention; first initial process registered by means of a user's customer device.

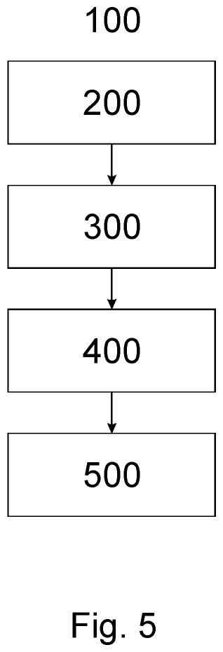

FIG. 5: A flowchart of an embodiment of the method for generating and delivering charging current for an electric vehicle according to the invention.

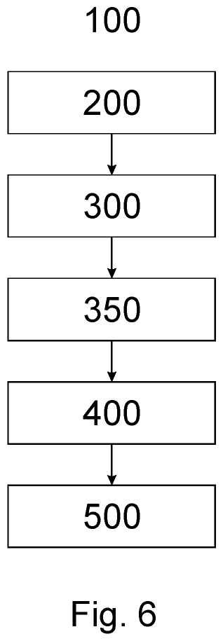

FIG. 6: A preferred variant of the method for generating and delivering charging current for an electric vehicle according to the invention

FIG. 1 shows an embodiment of the method 100 according to the invention, which registers the electric vehicle 10 to be charged by means of a sensor unit 4. The charging pole 1 has the power and HMI unit 2 and an energy conversion unit 3. The energy conversion unit 3 generates a primary charging current. Preferred is an energy conversion from a liquid and/or gaseous energy carrier into a charging current, e.g. by means of an internal combustion engine or a fuel cell. However, the energy conversion unit 3 can also be a solar cell that converts light into a current. It is also possible to generate a charging current by wind power. By means of the power and HMI unit 2, the amperage and voltage of the primary current is changed and, if necessary, an alternating current is converted into a direct current or vice versa.

The charging pole 1 is in stand-by mode between the individual charging processes. During this time, energy conversion in the energy conversion unit 3 does not take place or takes place only to such a limited extent that the power supply of the components arranged in the charging pole 1, such as sensor unit 4, control unit 9 and, if applicable, starting device of the energy conversion unit 3 or power and HMI unit 2, is guaranteed.

In this embodiment example, the sensor unit 4 has a close-range sensor 5.2 that detects the electric vehicle 10 at a distance of a few metres at a defined angle or in a full circle around the charging pole 1. This sensor 5.2 can be an ultrasonic, laser or radar sensor or also a camera, such as is installed in motor vehicles, e.g. for distance detection. Such a sensor 5.2 is therefore available and inexpensive. In addition, a camera 5.1 is arranged on the top of the charging pole 1 to detect a user and/or the electric vehicle 10 to be charged. A further sensor 5.3, an inductive loop, is arranged in the pavement of the charging location associated to the charging pole 1 and detects the electric vehicle 10 parked in the charging location. When the first initial process 200 is registered, the electric vehicle 10 to be charged is parked in the charging location associated to the charging pole 1. The electric vehicle 10 is located by means of the sensor unit 4 arranged in the charging pole

The sensor unit 4 is connected to the control unit 9. The control unit 9 evaluates 300 the first initial process 200 in this embodiment example in such a way that an arrival of an electric vehicle 10 to be charged at a charging location assigned to the charging pole 1 is registered. The charging process 400 is then started. First, the charging pole 1 is switched from the stand-by mode to a regular operating state by a wake-up 350. The energy conversion unit 3 is started and generates a charging current. A user gives a start command and can charge the electric vehicle 10 by means of the charging cable 8 arranged on the connection device 7. In the process, electrical energy is delivered from the charging pole 1 to the electric vehicle 10. After completion of the charging process 400, the charging pole 1 is returned to stand-by mode.

Another embodiment of the method according to the invention is shown in FIG. 2. The first initial process 200 is registered by the removal of the charging cable 8 from the connection device 7 by a user. The charging pole 1 has the power and HMI unit 2 and an energy conversion unit 3. The charging pole 1 is again in stand-by mode at the start of the process. To register the first initial process 200, the charging cable 8 is connected to the electric vehicle 10 to be charged, i.e. by means of a plug-in connection, the charging pole 1 and the electric vehicle 10 are connected by the charging cable 8.

In the next process step, the control unit 9 evaluates 300 this first initial process 200. For this purpose, charging parameters are transmitted from and received by both the charging pole 1 and the electric vehicle 10 via the charging cable 8. Depending on the charging parameters, the control unit 9 controls the following charging process 400. The charging parameters include in particular the current output (current intensity and current output) delivered by the charging pole 1 to the electric vehicle 10. The charging time can also be calculated and displayed to a user.

Furthermore, depending on the design of the charging pole 1 and the electric vehicle 10 to be charged, it can be evaluated 300 whether the electric vehicle 10 must be charged with alternating current or direct current. For example, the electric vehicle 10 to be charged may be equipped with a rectifier, which is determined by the control unit 9. In this case, the electric vehicle 10 is charged with an alternating current.

After the evaluation 300, the charging pole 1 is switched from stand-by mode to a regular operating state by a wake-up 350. The charging process 400 is then started. The energy conversion unit 3 is started and generates a charging current which is delivered to the electric vehicle 10. After completion of the charging process 400, the charging pole 1 is returned to stand-by mode.

FIG. 3 shows an embodiment example of the method 100 according to the invention, in which the first initial process 200 is registered by authentication of a user.

The charging pole 1 has the power and HMI unit 2 and an energy conversion unit 3. The charging pole 1 is in stand-by mode at the beginning of the process. To register the first initial process, a user makes a first entry into the display and operating terminal 6. In this embodiment, the display and operating terminal 6 has a keypad 6.2 with a fingerprint sensor 5.2, a sensor for facial recognition 5.1 and a card reader 6.3. The user authenticates himself using the display and operating terminal 6.

In the next process step, the control unit 9 evaluates 300 this first initial process 200. Depending on the charging parameters, the control unit 9 controls the following charging process 400. The charging parameters include, in particular, the current output (current intensity and current output) delivered by the charging pole 1 to the electric vehicle 10. The charging time can also be calculated and displayed to a user.

After the evaluation 300, the charging pole 1 is switched from stand-by mode to a regular operating state by a wake-up 350, the energy conversion unit 3 is started. The charging process 400 is then started by connecting the charging cable 8 to the electric vehicle 10 and the user giving a start command to start the charging process 400. The charging current generated by the charging pole 1 is delivered to the electric vehicle 10. After completion of the charging process 400, the charging pole 1 is returned to stand-by mode.

A further embodiment example of the method 100 according to the invention is shown in FIG. 4, in which the first initial process 200 is registered via a first input of a user into a customer device 11. In this embodiment, the first initial process 200 is a pre-registration of a user who wants to carry out a charging process at a charging pole 1 in a specific time window or at a specific time and at a specific location.

The charging pole 1 has the power and HMI unit 2 and an energy conversion unit 3. The charging pole 1 is in stand-by mode at the beginning of the process. For registration of the first initial process 200, a user makes a first input into the customer device 11, e.g. a smartphone, notebook, notepad, PC, which has a corresponding computer program/app. Via internet connection, the customer device 11 is connected to a cloud storage C, which in turn is connected to a charging pole 1. It is also possible that the cloud storage C is connected to a plurality of charging poles 1 in order to be able to select a suitable charging pole 1 for the time period selected for the user in the first initial process 200.

In the next method step, the control unit 9 evaluates 300 this first initial process 200 in such a way that the charging pole 1 starts the charging process at the time or time window specified in the first initial process 200. In this embodiment, a user can reserve a charging pole 1 for a charging process at such an early point in time that, when the electric vehicle 10 arrives at the charging pole 1, the energy conversion unit 3 is started, i.e. the maximum possible charging power can be delivered to the electric vehicle 10 when the transmission of 500 electrical energy to the electric vehicle 10 begins.

The actual transfer of electrical energy 500 from the charging pole 1 to the electric vehicle 10 is again performed by a start command from a user after the charging cable 8 is connected to the electric vehicle 10. After the charging process 400 is completed, the charging pole 1 is returned to stand-by mode.

All of these ways of registering a first initial process 200 set out in these four embodiment examples (FIGS. 1-4) can also be combined with each other to achieve the fastest possible charging of an electric vehicle 10.

FIG. 5 shows the method flow of an embodiment example of the method 100 according to the invention. The method 100 according to the invention starts with the registration of a first initial process 200, as shown in the previous embodiment examples by a user input or by the reception of a sensor signal. In the next method step, the first initial process is evaluated 300. In particular, the time of the start of the charging process 400 as well as further parameters such as charging current power and duration of the charging process 400 are evaluated 300. In the next method step, the charging process 400 starts at the time evaluated in the previous method step with the evaluated parameters. In the last process step, electrical energy is transferred 500 from the charging pole 1 to an electric vehicle 10. After completion of the charging process 400, the charging pole 1 is returned to stand-by mode.

A preferred variant of the method 100 according to the invention is shown in FIG. 6. The method 100 according to the invention starts with the registration of a first initial process 200 by a user input or by the reception of a sensor signal. In the next process step, the first initial process 200 is evaluated 300. In particular, the time of the start of the charging process 400 as well as further parameters such as charging current power and duration of the charging process 400 are evaluated 300. Thereafter, the charging pole 1 is switched from stand-by mode to a regular operating state 350 by a wake-up 350. The energy conversion unit 3 is started and generates a charging current. A user gives a start command and can charge the electric vehicle 10 by means of the charging cable 8 arranged on the connection device 7. In the next process step, the charging process 400 starts at the evaluated time with the evaluated parameters. During this process, electrical energy is delivered from the charging pole 1 to the electric vehicle 10. After completion of the charging process 400, the charging pole 1 is returned into stand-by mode.

### REFERENCE LIST

1 Charging pole

2 Power and HMI unit

3 Energy conversion unit

4 Sensor unit

5.1,5.2,5.3 Sensor

6 Display and operating terminal

6.1,6.2,6.3 Display and control element

7 Connection device for charging cable

8 Charging cable

9 Control unit

10 Electric vehicle

11 Customer device

C Cloud

100 Method for generating and delivering charging current

200 first initial process

300 Evaluation

350 Wake-up process

400 charging process

500 Transmission of electrical energy

1. A method for generating and delivering charging current (100) for an electric vehicle (10) in a charging pole (1)
register (200) a first initial process
evaluate (300) the first initial process
start of charging process (400) depending on evaluation result
characterised in that
the first initial process (200) is different from a start command of a user to start a charging process (400).

2. The method for generating and delivering charging current (100) for an electric vehicle (10) in a charging pole (1) according to claim 1
characterised in that
the first initial process (200) is the reception of a sensor signal.

3. The method for generating and delivering charging current (100) for an electric vehicle (10) in a charging pole (1) according to claim 1,
characterised in that
the sensor signal is evaluated (300) by a control unit (9) in the charging pole.

4. The method for generating and delivering charging current (100) for an electric vehicle (10) in a charging pole (1) according to claim 1
characterised in that
the first initial process (200) is performed by a first input from a user.

5. The method for generating and delivering charging current (100) for an electric vehicle (10) in a charging pole (1) according to claim 4
characterised in that
the first input of the user is made by a first input at an element (6.1, 6.2, 6.3) of the charging pole (1).

6. The method for generating and delivering charging current (100) for an electric vehicle (10) in a charging pole (1) according to claim 5
characterised in that
the user's first input at an element (6.1, 6.2, 6.3) of the charging pole (1) is made by a first input at the control panel (6).

7. The method for generating and delivering charging current (100) for an electric vehicle (10) in a charging pole (1) according to claim 4
characterised in that
the first input of the user is made by removing and/or connecting a charging cable (8).

8. The method for generating and delivering charging current (100) for an electric vehicle (10) in a charging pole (1) according to claim 4
characterised in that
the user's first input is via a network to the charging pole (1).

9. The method for generating and delivering charging current (100) for an electric vehicle (10) in a charging pole (1) according to claim 8
characterised in that
the first entry of the user is made by a pre-registration of the user via app/internet.

10. The method for generating and delivering charging current (100) for an electric vehicle (10) in a charging pole (1) according to claim 1
characterised in that
the first initial process (200) is performed by detecting a vehicle in the charging location.

11. The method for generating and delivering charging current (100) for an electric vehicle (10) in a charging pole (1) according to claim 1
characterised in that
the first initial process (200) is performed by authenticating the user.

12. The method for generating and delivering charging current (100) for an electric vehicle (10) in a charging pole (1) according to claim 1
characterised in that
the start of the charging process (400) comprises a wake-up (350) from stand-by mode.

13. The method for generating and delivering charging current (100) for an electric vehicle (10) in a charging pole (1) according to claim 1
characterised in that
the start of the charging process (400) comprises starting the energy conversion.

14. The method for generating and delivering charging current (100) for an electric vehicle (10) in a charging pole (1) according to claim 1
characterised in that
the start of the charging process (400) comprises a transfer of energy to an electric vehicle (10).

15. A charging pole (1) suitable and intended for charging electric vehicles (10), comprising
an energy conversion unit (3)
a power and HMI unit (2)
a control unit (9) for controlling the charging process (400)
characterised in that
the charging pole (1) has a sensor unit (4).

16. The charging pole (1) suitable and intended for charging electric vehicles (10) according to claim 15
characterised in that
the sensor unit (4) is coupled to the control unit (9) in the charging pole (1).

17. The charging pole (1) suitable and intended for charging electric vehicles (10) according to claim 15
characterised in that
the sensor unit (4) is suitable for detecting a vehicle (10) on a charging location assigned to the charging pole (1).

18. The charging pole (1) suitable and intended for charging electric vehicles (10) according to one or more of claims 15
characterised in that
the sensor unit (4) is adapted to detect the removal and/or connection of a charging cable (8).
